(19) United States
(12) Patent Application Publication
(10) Pub. No.: US 2007/0268298 A1
(43) Pub. Date: Nov. 22, 2007

(54) Delayed frame buffer merging with compression

(76) Inventors: Jonah M. Alben, San Jose, CA (US); John M. Danskin, Providence, RI (US); Henry P. Moreton, Woodside, CA (US)

Correspondence Address: MURABITO HAO & BARNES LLP, Third Floor, Two North Market Street, San Jose, CA, 95113, US

(21) Appl. No.: 11/804,025

(22) Filed: May 15, 2007

Related U.S. Application Data
(60) Provisional application No. 60/802,746, filed on May 22, 2006.

(51) Int. Cl. G06T 1/60

(52) U.S. Cl. 345/530

(57) ABSTRACT

A method for delayed frame buffer merging. The method includes accessing a polygon that relates to a group of pixels stored at a memory location, wherein each of the pixels has an existing color. A determination is made as to which of the pixels are covered by the polygon, wherein each pixel includes a plurality of samples. A coverage mask is generated corresponding the samples that are covered by the polygon. The group of pixels is updated by storing the coverage mask and a color of the polygon in the memory location. At a subsequent time, the group of pixels is merged into a frame buffer.

This application claims the benefit of U.S. Provisional Patent Application No. 60/802,746, Attorney Docket No. NVID-P002512 “DELAYED FRAME BUFFER MERGING WITH COMPRESSION”, by Alben, et al., which is incorporated herein in its entirety.

### FIELD OF THE INVENTION

The present invention is generally related to graphics computer systems.

### BACKGROUND OF THE INVENTION

Generally, a computer system suited to handle 3D image data includes a specialized graphics processor unit, or GPU, in addition to a traditional CPU (central processing unit). The GPU includes specialized hardware configured to handle 3D computer-generated objects. The GPU is configured to operate on a set of data models and their constituent “primitives” (usually mathematically described triangle polygons) that define the shapes, positions, and attributes of the objects. The hardware of the GPU processes the objects, implementing the calculations required to produce realistic 3D images on a display of the computer system.

The performance of a typical graphics rendering process is largely dependent upon the performance of the system's underlying hardware. High performance real-time graphics rendering requires high data transfer bandwidth and low latency to the memory storing the 3D object data and the constituent primitives. Thus, a significant amount of developmental effort has been devoted to increasing transfer bandwidth and reducing data access latencies to memory.

Accordingly, more expensive prior art GPU subsystems (e.g., GPU equipped graphics cards, etc.) typically include large (e.g., 128 MB or larger) specialized, expensive, high bandwidth local graphics memories for feeding the required data to the GPU. Such GPUs often include large on-chip caches and sets of registers having very low data access latency. Less expensive prior art GPU subsystems include smaller (e.g., 64 MB or less) such local graphics memories, and some of the least expensive GPU subsystems have no local graphics memory, and instead rely on the system memory for storing graphics rendering data.

A problem with each of the above described types of prior art GPUs is the fact that the data transfer bandwidth to the system memory, or local graphics memory, is much less than the data transfer bandwidth to the caches and registers internal to the GPU. For example, GPUs need to read command streams and scene descriptions and determine the degree to which each of the pixels of a frame buffer are affected by each of the graphics primitives comprising a scene. This process can cause multiple reads and writes to the frame buffer memory storing the pixel data. Although the on-chip caches and registers provide extremely low access latency, the large number of pixels in a given scene (e.g., 1280×1024, 1600×1200 etc.) make numerous accesses to the frame buffer inevitable.

Large latency induced performance penalties are thus imposed on the overall graphics rendering process. The performance penalties are much greater for those GPUs that store their frame buffers in system memory. Rendering processes which require reads and writes to multiple samples per pixel (e.g., anti-aliasing, etc.) are especially susceptible to such latency induced performance penalties.

Thus, what is required is a solution capable of reducing the limitations imposed by the data transfer latency of the communications pathways to local graphics memory and/or the communications pathways to system memory. The present invention provides a novel solution to the above requirements.

### SUMMARY OF THE INVENTION

In one embodiment, the present invention is implemented as a GPU implemented method for delayed frame buffer merging. The method includes accessing a polygon that relates to a group of pixels stored at a memory location (e.g., one or more tiles), wherein each of the pixels have an existing color. A determination is made as to which of the pixels are covered by the polygon, wherein each pixel includes a plurality of samples. A coverage mask corresponding to the samples that are covered by the polygon is generated. The group of pixels is updated by storing the coverage mask and a color of the polygon in the memory location. At a subsequent time, the group of pixels is merged into a frame buffer.

In one embodiment, multiple polygons are updated into the pixel group, whereby the GPU accesses multiple subsequent polygons related to the group of pixels (e.g., subsequent polygons partially covering the pixels). For each of the subsequent polygons, the group of pixels is updated by storing a respective coverage mask and a respective color of each subsequent polygon in the memory location.

In one embodiment, a tag value is used to track a state of the memory location storing the group of pixels, wherein the tag value is updated in accordance with the subsequent polygons. Additionally, the tag value can be used to determine when the memory location storing the group of pixels is full, and thereby indicate when the group of pixels should be merged into the frame buffer.

In this manner, the delayed frame buffer merging process of the present invention can accumulate updates from arriving polygons into a pixel group within low latency memory (e.g., registers, caches), as opposed to having to read and write to the frame buffer and thereby incur high latency performance penalties. The delayed frame buffer merging process thus ameliorates the bottlenecks imposed by the higher data access latencies of the local graphics memory and the system memory.

### BRIEF DESCRIPTION OF THE DRAWINGS

The present invention is illustrated by way of example, and not by way of limitation, in the Figures of the accompanying drawings and in which like reference numerals refer to similar elements.

FIG. 1 shows a computer system in accordance with one embodiment of the present invention.

FIG. 2 shows a flowchart of the steps of a process in accordance with one embodiment of the present invention.

FIG. 3 shows an illustration of a determination as to which pixels of a group are covered by a polygon in accordance with one embodiment of the present invention.

FIG. 4 shows a diagram depicting the resulting samples from a coverage evaluation of a polygon on a group of pixels in accordance with one embodiment of the present invention.

FIG. 5 shows a coverage mask stored into a memory location for a group of pixels in accordance with one embodiment of the present invention.

FIG. 6 shows a subsequent polygon covering the group of pixels in accordance with one embodiment of the present invention.

FIG. 7 shows the samples of the pixels that are covered by the polygon where one pixel is completely uncovered in accordance with one embodiment of the present invention.

FIG. 8 shows the resulting coverage mask and color of a polygon stored in one quadrant of a memory location in accordance with one embodiment of the present invention.

FIG. 9 shows a subsequent polygon covering the group of pixels in accordance with one embodiment of the present invention.

FIG. 10 shows the samples of the pixels that are covered by the polygon where one pixel is completely uncovered in accordance with one embodiment of the present invention.

FIG. 11 shows the resulting coverage mask and color of the polygon stored in the lower right quadrant of the memory location in accordance with one embodiment of the present invention.

FIG. 12 shows a subsequent polygon covering the pixel group in accordance with one embodiment of the present invention.

FIG. 13 shows the memory location with a first color in the top left quadrant of the memory location in accordance with one embodiment of the present invention.

FIG. 14 shows a pixel group being operated on by a delayed frame buffer merge process in accordance with an alternative embodiment of the present invention.

FIG. 15 shows the memory location where the color information is stored under one scheme in accordance with the present invention.

FIG. 16 shows the tag values under a second scheme in accordance with an alternative embodiment of the present invention.

FIG. 17 shows a second illustration of the memory location where the color information is stored under the alternative embodiment of the present invention.

FIG. 18 shows two samples and their respective colors as indicated by their corresponding coverage masks in accordance with one embodiment of the present invention.

FIG. 19 shows four additional samples and their respective colors as indicated by their corresponding coverage masks in accordance with one embodiment of the present invention.

FIG. 20 shows for successive states of a pixel group as color information is composited in accordance with one embodiment of the present invention.

### DETAILED DESCRIPTION OF THE INVENTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail as not to unnecessarily obscure aspects of the embodiments of the present invention.

### Notation and Nomenclature:

Some portions of the detailed descriptions, which follow, are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

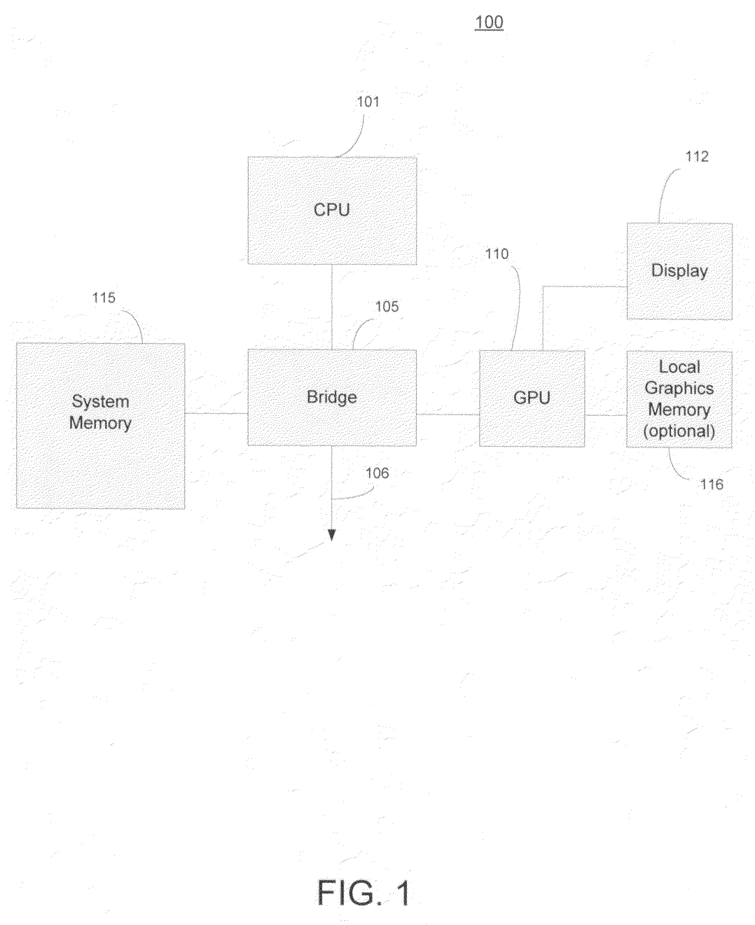

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “compressing” or “storing” or “rendering” or the like, refer to the action and processes of a computer system (e.g., computer system 100 of FIG. 1), or similar electronic computing device, that manipulates and transforms data represented as physical (electronic) quantities within the computer system's registers and memories into other data similarly represented as physical quantities within the computer system memories or registers or other such information storage, transmission or display devices.

### Computer System Platform:

FIG. 1 shows a computer system 100 in accordance with one embodiment of the present invention. Computer system 100 depicts the components of a basic computer system providing the execution platform for certain hardware-based and software-based functionality. In general, computer system 100 comprises at least one CPU 101, a system memory 115, and at least one graphics processor unit (GPU) 110. The CPU 101 can be coupled to the system memory 115 via the bridge component 105 or can be directly coupled to the system memory 115 via a memory controller (not shown) internal to the CPU 101. The bridge component 105 (e.g., Northbridge) can support expansion buses (e.g., expansion bus 106) that connect various I/O devices (e.g., one or more hard disk drives, Ethernet adapter, CD ROM, DVD, etc.). The GPU 110 is coupled to a display 112. One or more additional GPUs can optionally be coupled to system 100 to further increase its computational power. The GPU(s) 110 is coupled to the CPU 101 and the system memory 115 via the bridge component 105. System 100 can be implemented as, for example, a desktop computer system or server computer system, having a powerful general-purpose CPU 101 coupled to a dedicated graphics rendering GPU 110. In such an embodiment, components can be included that add peripheral buses, specialized local graphics memory, IO devices, and the like. Similarly, system 100 can be implemented as a handheld device (e.g., cell phone, etc.) or a set-top video game console device such as, for example, the Xbox®, available from Microsoft Corporation of Redmond, Wash., or the PlayStation3®, available from Sony Computer Entertainment Corporation of Tokyo, Japan.

It should be appreciated that the GPU 110 can be implemented as a discrete component, a discrete graphics card designed to couple to the computer system 100 via a connector (e.g., AGP slot, PCI-Express slot, etc.), a discrete integrated circuit die (e.g., mounted directly on the motherboard), or as an integrated GPU included within the integrated circuit die of a computer system chipset component (e.g., integrated within the bridge chip 105). Additionally, a local graphics memory 116 can optionally be included for the GPU 110 to provide high bandwidth graphics data storage.

### Embodiments of the Present Invention

Embodiments of the present invention implement a method for delayed frame buffer merging. In one embodiment, the GPU utilizes a tag value and a sub-portion of a frame buffer tile to store a coverage mask. The coverage mask corresponds to the degree of coverage of the tile (e.g., the number of samples covered). The pixels comprising the frame buffer tile can be stored in a compressed state by storing the color of a polygon and the coverage mask of the polygon into the memory location that stores the tile. Furthermore, additional polygons can be rendered into the tile by storing a subsequent coverage mask for a new polygon and a color for the new polygon into the memory location.

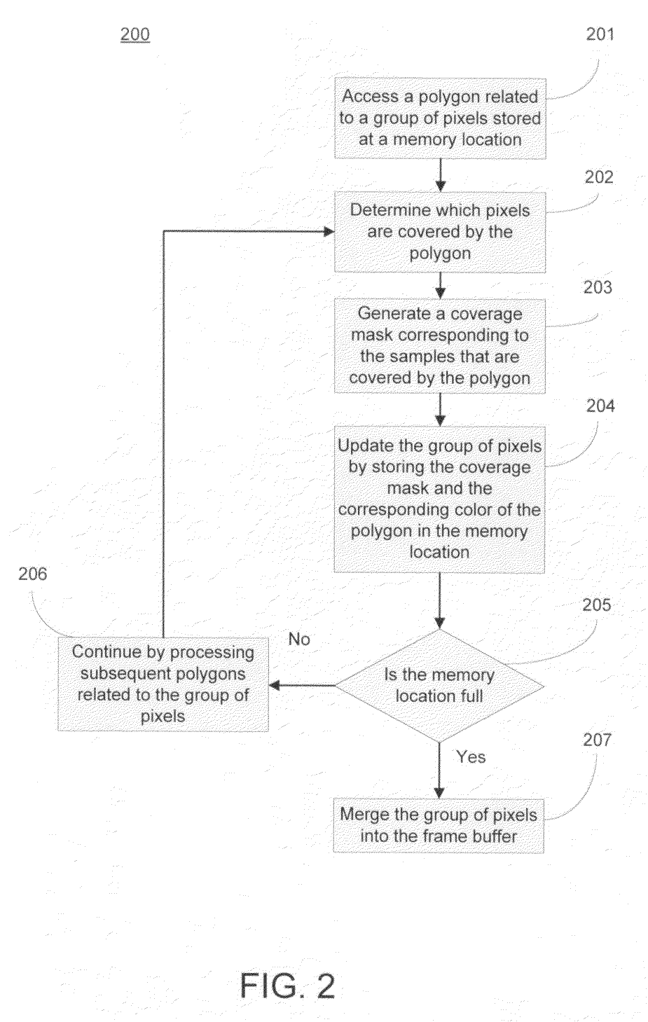

This enables new polygons to be rendered into the tile without having to access and write to the frame buffer. For example, polygons can be rendered into the tile using the delayed frame buffer merging process until the tile is full, at which point the tile can be merged into the frame buffer. In this manner, the delayed frame buffer merging process of the present invention can accumulate updates from arriving polygons into a tile within the limited size of the low latency memory (e.g., registers, caches) of the GPU 110, as opposed to having to read and write to the frame buffer (e.g., stored in local graphics memory 116 or in the system memory 115) and thereby incur high latency performance penalties. The delayed frame buffer merging process is described in greater detail in FIG. 2 below.

FIG. 2 shows a flowchart of the steps of a process 200 in accordance with one embodiment of the present invention. As depicted in FIG. 2, process 200 depicts the operating steps involved in a delayed frame buffer merging process as implemented by a GPU (e.g., GPU 110) of a computer system (e.g., computer system 100) in accordance with one embodiment of the present invention.

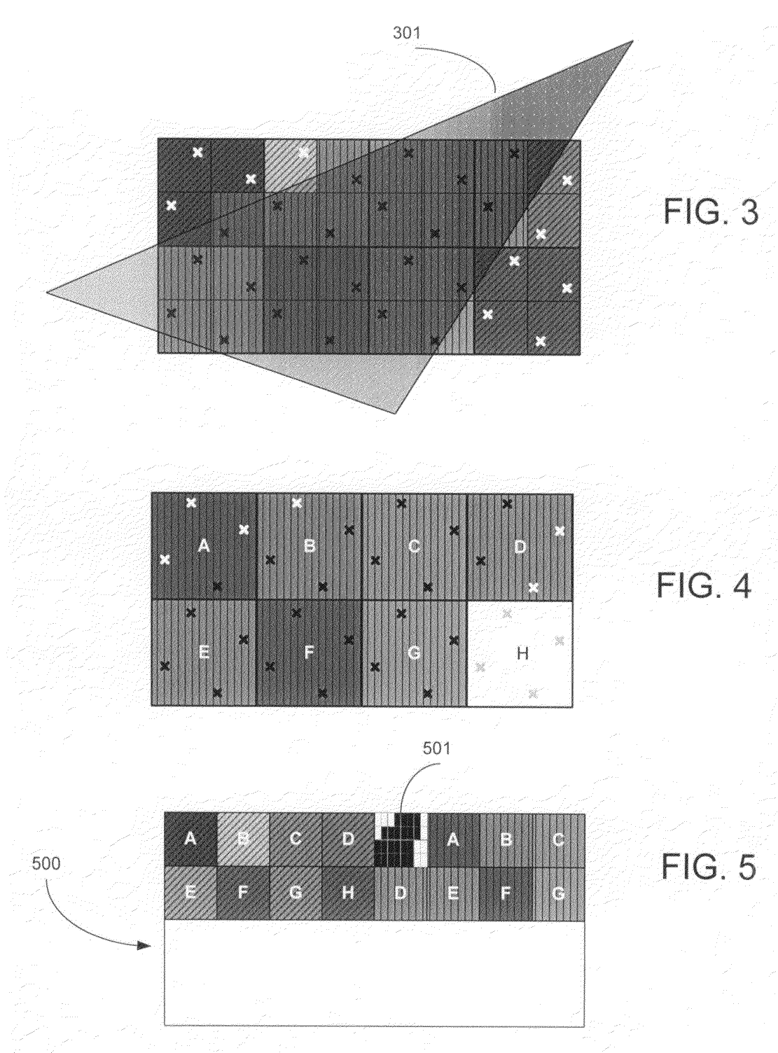

The steps of the process 200 embodiment of FIG. 2 are described in the context of, and with reference to, the exemplary computer system 100 of FIG. 1 and the FIGS. 3-13.

Process 200 begins in step 201 where GPU 110 accesses a polygon related to a group of pixels stored at a memory location. During the rendering process, the GPU 110 receives primitives, usually triangle polygons, which define the shapes, positions, and attributes of the objects comprising a 3-D scene. The hardware of the GPU processes the primitives and implements the calculations required to produce realistic 3D images on the display 112. At least one portion of this process involves the rasterization and anti-aliasing of polygons into the pixels of a frame buffer, whereby the GPU 110 determines the degree to which each of the pixels of the frame buffer are affected by each of the graphics primitives comprising a scene. In one embodiment, the GPU 110 processes pixels as groups, which are often referred to as tiles. These groups, or tiles, typically comprise four pixels per tile (e.g., although tiles having 8, 12, 16, or more pixels can be implemented). In one embodiment, the GPU 110 is configured to process two adjacent tiles (e.g., comprising eight pixels).

In step 202, process 200 determines which pixels of the group are covered by the polygon. This determination as to which pixels are covered by the polygon is illustrated in FIG. 3, which shows a diagram of a polygon 301 being rasterized against a group comprising eight pixels. FIG. 3 shows two tiles side-by-side having four pixels each. Each pixel is further divided into four sub pixels, with each sub pixel having one sample point, depicted as an “x” in FIG. 3, resulting in 16 sample points as used in, for example, 4× anti-aliasing. FIG. 4 shows the resulting samples, whereby, the sample points that are covered by the polygon are darkened while the sample points that are not covered by the polygon are not. As shown in FIG. 4, the pixels are labeled A, B, C, D, E, F, G, and H. Note that pixel H is completely uncovered.

In step 203, a coverage mask is generated corresponding to the samples that are covered by the polygon 301. In one embodiment, the coverage mask can be implemented as a bit mask with one bit per sample of the group. Thus, 16 bits can represent the 16 samples of the group, with each bit being set in accordance with whether that sample is covered or not. Thus, in a case where the polygon 301 partially covers the pixels of the group, and thus partially covers the 16 samples, this information, namely the degree of coverage, can be updated into the group by storing the resulting coverage mask and the color of the polygon 301 into the memory location storing the tile.

Importantly, it should be noted that this update can occur within memory internal to the GPU 110. This memory stores the pixel group as it is being rasterized and rendered against polygons. Thus a polygon can be rasterized and rendered into the pixel group without having to read the pixel group from the frame buffer, update the pixel group, and then write the updated pixel group back to the frame buffer (e.g., read-modify-write).

In step 204, the group of pixels is updated by storing the coverage mask and the corresponding color of the polygon into the memory location for the group. This is shown in FIG. 5. It should be noted that the coverage mask is stored in the memory which is vacant due to the pixel H being completely uncovered. As illustrated in FIG. 5, the memory location storing the group of pixels is depicted as a rectangle 500 having four quadrants. One fourth of the space (e.g., the top left quadrant) stores a compressed background color, or prior compressed color, of the eight pixels, where, for example, a single previous polygon completely covered all eight pixels, and thus the samples can be compressed 4-to-1 and stored as one color per pixel. The top right quadrant stores the coverage mask 501 and one color for the pixels A through G. As described above, the coverage mask indicates which samples were covered by the polygon.

In this manner, the delayed frame buffer merging process of the present invention can accumulate a number of updates from arriving polygons into a pixel group while delaying the necessity of merging the updates into the frame buffer.

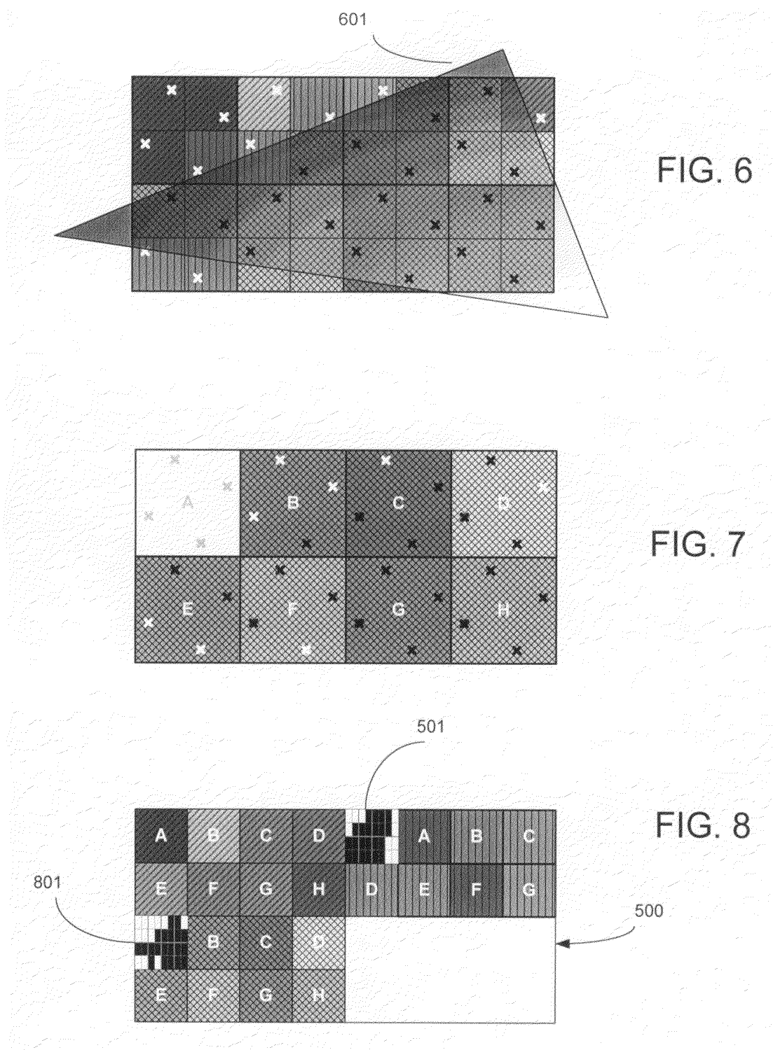

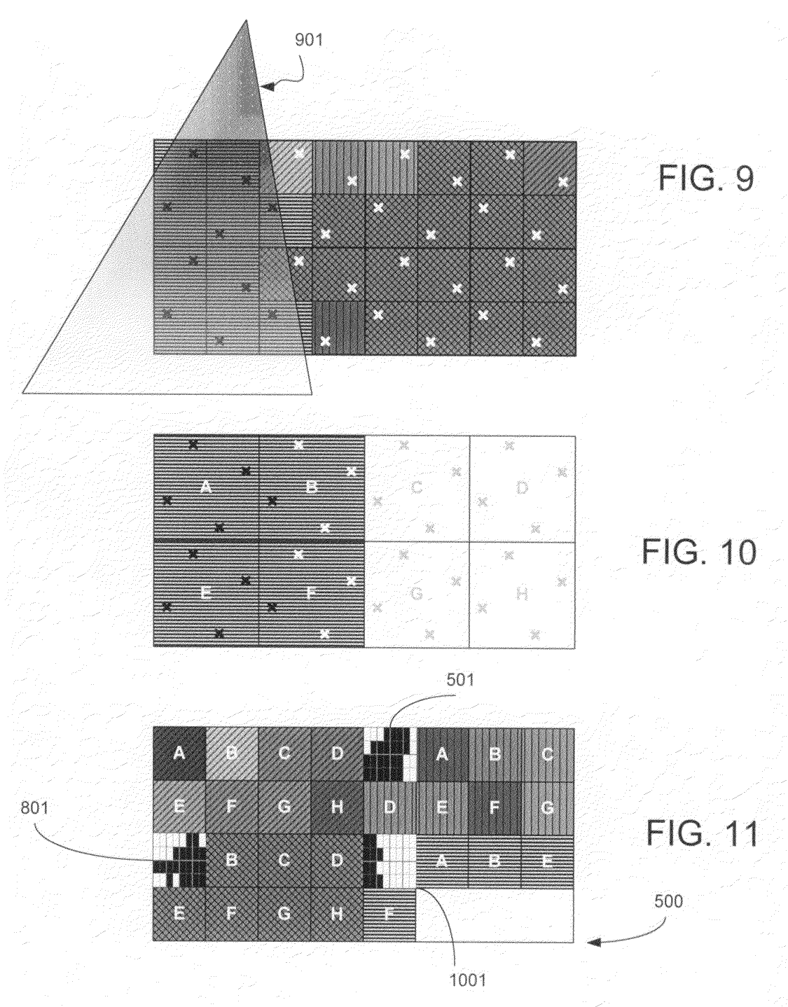

Referring still to process 200 of FIG. 2, in step 205, a determination is made as to whether the memory location 500 is full. In one embodiment, this determination is made by monitoring a number of tag bits maintained within an internal memory of the GPU, where the tag bits indicate which portions of the memory location 500 is full/empty. If the memory location is not full, process 200 can proceed to step 206 and continue processing subsequent polygons related to the group of pixels, and for each of the subsequent polygons, perform steps 202 through 204. For example, FIG. 6 shows a subsequent polygon 601 covering the group of pixels, FIG. 7 shows the samples of the pixels that are covered by the polygon 601, with pixel A being completely uncovered, and FIG. 8 shows the resulting coverage mask 801 and color of polygon 601 stored in the lower left quadrant of the memory location 500. FIG. 9 then shows a subsequent polygon 901 covering the group of pixels, FIG. 10 shows the samples of the pixels that are covered by the polygon 901, with pixels C, D, G, and H being completely uncovered, and FIG. 11 shows the resulting coverage mask 1001 and color of polygon 901 stored in the lower right quadrant of the memory location 500.

In this manner, the delayed frame buffer merging process of the present invention can accumulate a number of updates from arriving polygons into a pixel group, thereby delaying the necessity of a merge operation until the memory for the pixel group is full. This reduces the total number of merge operations, which each require a time consuming read, modify, and write to the frame buffer, which must be performed to render a given scene. As described above, the pixel group can be updated with subsequent polygons without forcing a merge into the frame buffer for each polygon.

In step 207, when the memory location 500 is full as shown in FIG. 11, when a subsequent polygon arrives, the information stored in the memory location 500 needs to be uncompressed and composited with the new polygon. This information can then be merged into the frame buffer. Once merged into the frame buffer, the information can remain in an uncompressed form.

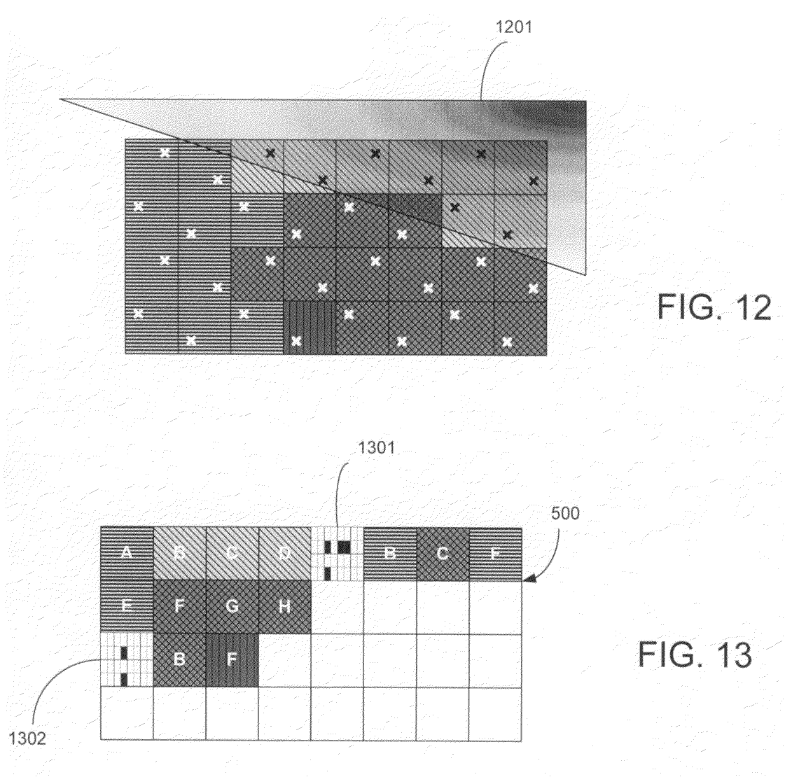

In one embodiment, after the information is merged into the frame buffer, the GPU 110 can recompress the color information of the pixel group and store the pixel group in a compressed form in low latency memory. This color information can be compressed using coverage masks and colors as described above. This process is illustrated in FIG. 12, where a subsequent polygon 1201 covers the pixel group. After the information stored in the memory location 500 is uncompressed and composited with the polygon 1201, the information is recompressed and stored within the memory location 500 as shown in FIG. 13. FIG. 13 shows the memory location 500 with a first color in the top left quadrant (e.g., a background color), a coverage mask 1301 and a second color corresponding to the coverage mask 1301 in the top right quadrant, and a coverage mask 1302 a third color corresponding to the coverage mask 1302 in the bottom left quadrant. Thus, after recompression, the bottom right quadrant of memory location 500 is open to receive another polygon.

It should be noted that if a subsequent polygon is received that completely covers all of the pixels of the group, all the samples in each pixel would be the same color and can thus be 4 to 1 compressed and stored as a single color in, for example, the top left quadrant. It should be noted that although embodiments of the present invention have been described in the context of 4× multisampling, the present invention would be even more useful in those situations where even higher levels of multisampling are practiced (e.g., 8× multisampling, etc.) and in applications other than anti-aliasing.

Additionally, it should be noted that in one embodiment, a tag value is used by the GPU 110 to keep track of the state of the memory location 500 for the group of pixels. This tag value enables the GPU 110 to keep track of the number of polygons that have been updated into the memory location 500. For example, in one embodiment, the tag value can be implemented as a 3 bit value, where, for example, tag value 0 indicates a 4 to 1 compression with one color per pixel, tag value 1 indicates 4 to 1 compression with two quadrants of the memory location 500 occupied, as shown in FIG. 5, tag value 3 indicates 4 to 1 compression with three quadrants of the memory location 500 occupied, as shown in FIG. 8, and tag value 4 indicates 4 to 1 compression with all four quadrants of the memory location 500 occupied, as shown in FIG. 11.

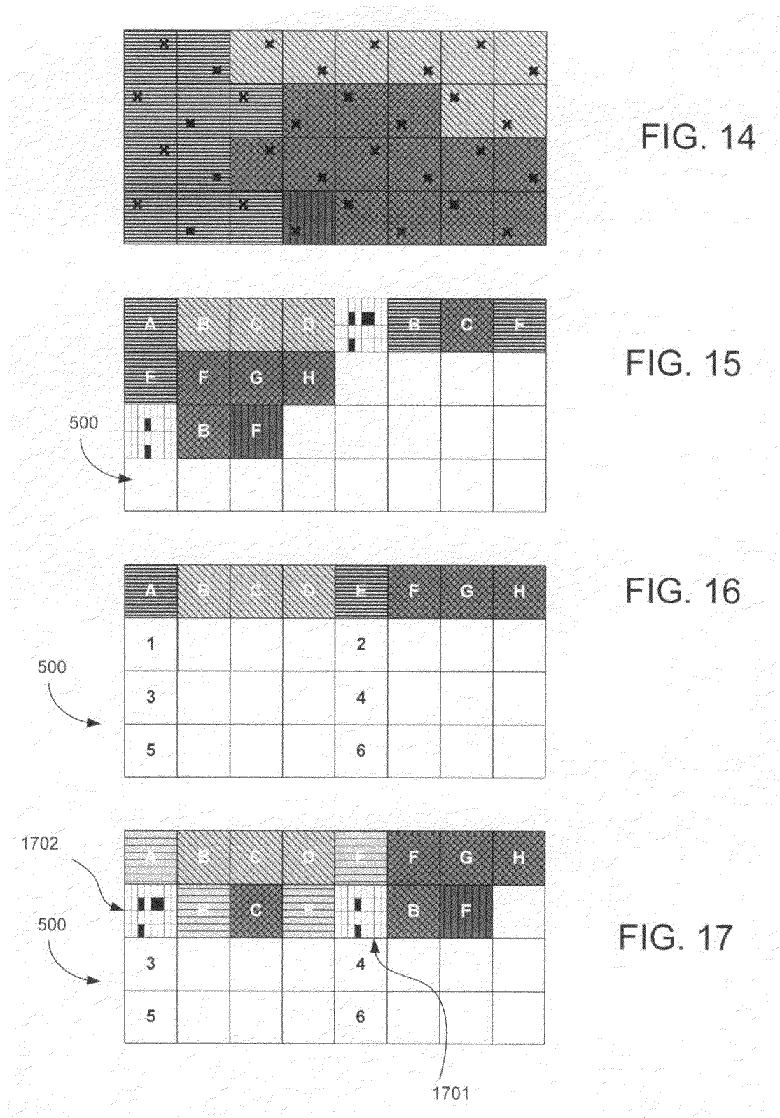

FIGS. 14 through 16 illustrate a delayed frame buffer merge process in accordance with an alternative embodiment of the present invention. In the alternative embodiment, the tag is implemented as a free pointer into the memory location 500. In such an embodiment, the memory location 500 can support as many as six updates without having to perform a merge with the frame buffer. In such an embodiment, the tag values can be implemented such that they have the following meaning:

0=uncompressed;
1=fully compressed, free pointer at sample 8;
2=multiple fragments, free pointer at sample 12;
3=free pointer at sample 16;
4=free pointer at sample 20;
5=free pointer at sample 24;
6=free pointer at sample 28;
7=memory location 500 full but still unresolved.

FIG. 14 shows a pixel group having colors in accordance with the indicated sample positions. FIG. 15 shows the memory location 500 where the color information is stored under the scheme described in the discussion of FIG. 2 above. FIG. 16 shows tag values which indicate the status (occupied/unoccupied) of the memory. The tag value indicates where the next free location is in the memory. It permits the GPU hardware to know where to store the next block of data. In cases where an update requires more than four entries, the tag is incremented by 2. Accordingly, FIG. 16 shows the tag values where tag value 1 is shown as the “1” stored at sample position 8 of the memory location 500, tag value 2 is shown as the “2” at sample position 16, and the like, through tag value 6 shown as the “6” at sample position 28, in accordance with the alternative embodiment. FIG. 17 shows the memory location 500 where the color information is stored under the scheme of the alternative embodiment of the present invention. Thus, as shown in FIG. 17, the pixel group can have a background color, and as many as six new updated colors, with the resulting coverage masks 1701-1702 stored at the sample positions 12 and 8 respectively, and the colors associated with the coverage masks 1701-1702 stored adjacent thereto.

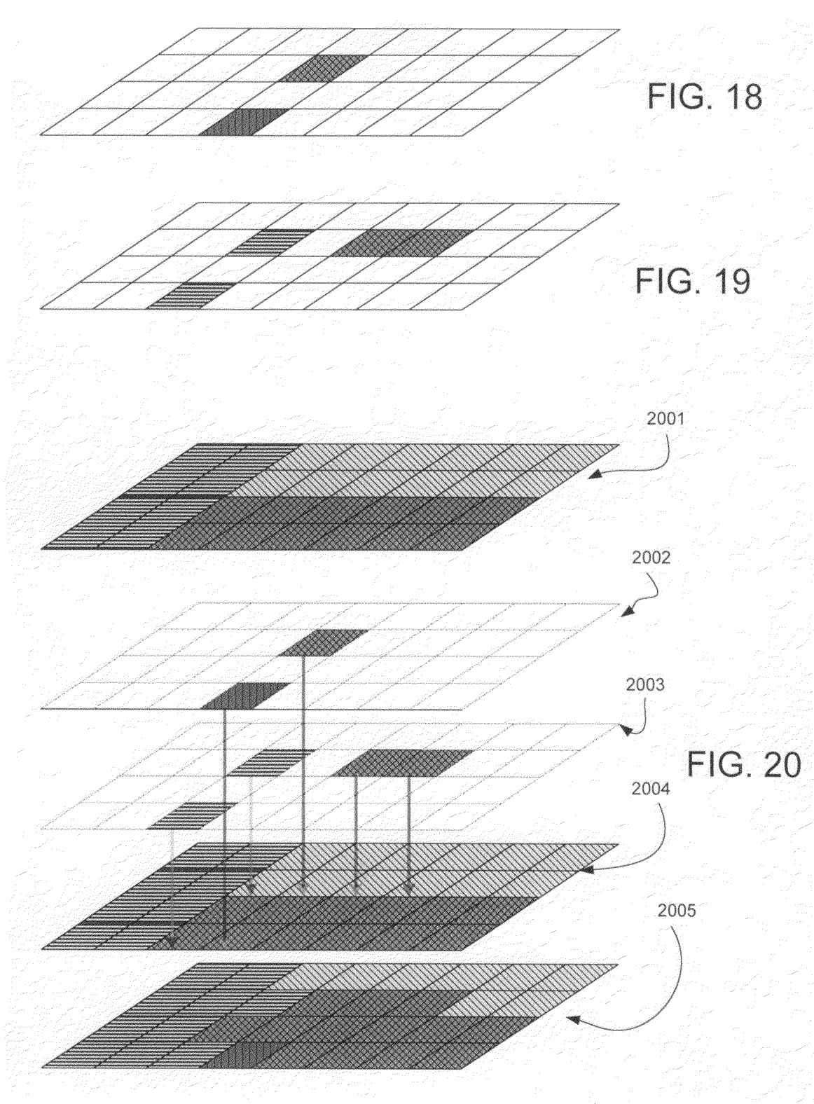

FIGS. 18 through 20 visually illustrate the manner in which the coverage masks capture the updates from subsequently arriving polygons. For example, FIG. 18 shows the two samples and their respective colors as indicated by the coverage mask 1701 and FIG. 19 shows the two samples and their respective colors as indicated by the coverage masks 1702. FIG. 20 shows three successive states of the group of pixels illustrating the manner in which the final state of the group of pixels is built up within the memory location 500, where state 2002 shows an initial two samples, state 2003 shows a next two samples, state 2004 shows the colors as they are composited with the background colors, and the final state 2005 depicts the resulting information as it is stored within the memory location 500.

Thus, in accordance with the alternative embodiment, 16 byte writes are required which are not necessarily more efficient than 32 byte writes, but still save a read from the frame buffer. With deeper pixels or larger pixel footprints, the alternative embodiment method can still function with 3 bit tags. In the above described examples, the pixel groups comprise an eight pixel footprint. In a case where the pixel footprint comprises 16 pixel groups, then the process would allocate storage in eight sample increments or 32 byte grains. Alternatively, in a case where 8 byte pixels are being written, a 2×4 pixel group as used herein performs adequately for generating 32 byte writes.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method for frame buffer merging, comprising:
accessing a polygon that relates to a group of pixels stored at a memory location, wherein each of the pixels have an existing color;
determining which of the pixels are covered by the polygon, wherein each pixel comprises a plurality of samples;
generating a coverage mask corresponding the samples that are covered by the polygon;
updating the group of pixels by storing the coverage mask and a color of the polygon in the memory location; and
subsequently merging the group of pixels into a frame buffer.

2. The method of claim 1, further comprising:
accessing a plurality of subsequent polygons related to the group of pixels; and
for each of the subsequent polygons, updating the group of pixels by storing a respective coverage mask and a respective color of each subsequent polygon in the memory location.

3. The method of claim 2, further comprising:
using a tag value to track a state of the memory location storing the group of pixels; and
updating the tag value in accordance with the subsequent polygons.

4. The method of claim 2, further comprising:
determining when the memory location storing the group of pixels is full; and
merging the group of pixels into the frame buffer when memory location is full.

5. The method of claim 4, further comprising:
compressing the group of pixels into the memory location subsequent to the merging by storing at least one coverage mask and at least one color into the memory location in accordance with the colors of the pixels.

6. The method of claim 4, wherein the merging of the group of pixels into the frame buffer is configured to reduce a number of accesses to the frame buffer.

7. The method of claim 1, wherein the updating of the group of pixels into the memory location results in a 4 to 1 compression.

8. A computer readable media storing computer readable code which, when executed by a computer system having a processor coupled to a memory, cause the computer system to implement a computer readable media for delayed frame buffer merging, comprising:
accessing a polygon that relates to a group of pixels stored at a memory location, wherein each of the pixels have an existing color;
determining which of the pixels are covered by the polygon, wherein each pixel comprises a plurality of samples;
generating a coverage mask corresponding the samples that are covered by the polygon;
updating the group of pixels by storing the coverage mask and a color of the polygon in the memory location;
accessing a plurality of subsequent polygons related to the group of pixels;
for each of the subsequent polygons, updating the group of pixels by storing a respective coverage mask and a respective color of each subsequent polygon in the memory location; and
subsequently merging the group of pixels into a frame buffer.

9. The computer readable media of claim 8, further comprising:
using a tag value to track a state of the memory location storing the group of pixels; and
updating the tag value in accordance with the subsequent polygons.

10. The computer readable media of claim 8, further comprising:
determining when the memory location storing the group of pixels is full; and
merging the group of pixels into the frame buffer when memory location is full.

11. The computer readable media of claim 10, further comprising:
compressing the group of pixels into the memory location subsequent to the merging by storing at least one coverage mask and at least one color into the memory location in accordance with the colors of the pixels.

12. The computer readable media of claim 10, wherein the merging of the group of pixels into the frame buffer is configured to reduce a number of accesses to the frame buffer.

13. The computer readable media of claim 8, wherein the updating of the group of pixels into the memory location results in a 4 to 1 compression.

14. A computer system, comprising:
a processor;
a system memory coupled to the processor; and
a graphics processing unit coupled to the processor, wherein the graphics processor is configured to execute computer readable code which causes the graphics processor to implement a method for delayed frame buffer merging, comprising:
accessing a polygon that relates to a group of pixels stored at a memory location, wherein each of the pixels have an existing color;
determining which of the pixels are covered by the polygon, wherein each pixel comprises a plurality of samples;
generating a coverage mask corresponding the samples that are covered by the polygon;
updating the group of pixels by storing the coverage mask and a color of the polygon in the memory location;
accessing a plurality of subsequent polygons related to the group of pixels;
for each of the subsequent polygons, updating the group of pixels by storing a respective coverage mask and a respective color of each subsequent polygon in the memory location; and
subsequently merging the group of pixels into a frame buffer.

15. The computer system of claim 14, further comprising:
using a tag value to track a state of the memory location storing the group of pixels; and
updating the tag value in accordance with the subsequent polygons.

16. The computer system of claim 14, further comprising:
determining when the memory location storing the group of pixels is full; and
merging the group of pixels into the frame buffer when memory location is full.

17. The computer system of claim 16, further comprising:
compressing the group of pixels into the memory location subsequent to the merging by storing at least one coverage mask and at least one color into the memory location in accordance with the colors of the pixels.

18. The computer system of claim 14, further comprising:
using a tag value as a free pointer to track a state of the memory location storing the group of pixels; and
updating the tag value in accordance with the subsequent polygons.

19. The computer system of claim 14, wherein the frame buffer is stored in the system memory.

20. The computer system of claim 14, wherein the frame buffer is stored in a local graphics memory coupled to the graphics processing unit.
